(19) United States
(12) Patent Application Publication
(10) Pub. No.: US 2025/0293509 A1
(43) Pub. Date: Sep. 18, 2025

(54) SHORT CIRCUIT PROTECTION TECHNIQUES FOR ELECTRIFIED VEHICLE MULTI-STRING BATTERY PACKS CONNECTED VIA A SWITCHABLE BATTERY DISCONNECT UNIT

(71) Applicant: FCA US LLC, Auburn Hills, MI (US)

(72) Inventors: Mostafa S. Ahmed, Windsor (CA); Eric M. Streeter, Auburn Hills, MI (US); Swetha Murali, Windsor (CA); William Mu, Auburn Hills, MI (US); Timothy Mrosewske, Auburn Hills, MI (US); Karina K. Morley, Auburn Hills, MI (US); Qingyuan Tan, Windsor (CA)

(21) Appl. No.: 19/221,868

(22) Filed: May 29, 2025

Related U.S. Application Data
(63) Continuation-in-part of application No. 18/498,444, filed on Oct. 31, 2023, now Pat. No. 12,319,152.

(51) Int. Cl. H02H 7/18

(52) U.S. Cl. CPC H02H 7/18

(57) ABSTRACT

Short circuit protection techniques for a multi-string battery system of an electrified vehicle involves a switchable battery disconnect unit (BDU) including (i) a set of protection devices each including both a contactor and an integrated circuit breaker and (ii) a set of relays and a computing system configured to determine, from an initial state mapping for all potential combinations of states of the set of protection devices and the set of relays, one or more malfunction states each being a particular combination of states of the set of protection devices and the set of relays that will cause a short circuit malfunction of the battery system, and generate a final state mapping based on the initial state mapping and the one or more malfunction states such that the final state mapping does not allow the switchable BDU to be configured in any of the one or more malfunction states.

### CROSS-REFERENCE TO RELATED APPLICATION(S)

The present application is a continuation-in-part (CIP) of U.S. patent application Ser. No. 18/498,444, filed on Oct. 31, 2023. The disclosure of this application is incorporated herein by reference in its entirety.

### FIELD

The present application generally relates to electrified vehicle high voltage architectures and, more particularly, to a switchable high voltage architecture for electrified vehicles using protection devices that include contactors and integrated circuit breakers.

### BACKGROUND

Today's electrified vehicles have high voltage architectures for powering one or more electric motors. These high voltage architectures include a high voltage battery system that is selectively connected to a high voltage bus by closing one or more contactors, which allows for selective power on/off control of the high voltage bus for safety reasons. Thermal fuses are often implemented for current spike protection at the high voltage bus. When a thermal fuse is blown, however, it requires replacement, which could be a timely and costly service procedure. In addition, there is a possibility that the contactors could weld closed during high current spikes, regardless of the state of the thermal fuse(s). Contactor welding could further increase service time/costs. Accordingly, while such conventional electrified vehicle high voltage architectures do work well for their intended purpose, there exists an opportunity for improvement in the relevant art.

### SUMMARY

According to one example aspect of the invention, a switchable battery disconnect unit (BDU) system for an electrified vehicle is presented. In one exemplary implementation, the switchable BDU system comprises a switchable BDU for a high voltage battery system of the electrified vehicle, the switchable BDU including one or more protection devices that each include both a contactor and an integrated circuit breaker and a controller configured to control the switchable BDU to switch between 400 Volts (400V) and 800V direct current (DC) modes for powering an electrified powertrain of the electrified vehicle and for recharging the high voltage battery system and monitor and reset the protection device in response to an actuation of the integrated circuit breaker, wherein the protection device does not include a replaceable thermal fuse.

In some implementations, the protection device is configured to actuate or open the integrated circuit breaker in response to a current spike. In some implementations, the actuation or opening of the integrated circuit breaker prevents the current spike from welding the contactor closed. In some implementations, the high voltage battery system is separable into first and second high voltage batteries, and wherein the switchable BDU includes three protection devices and five relays. In some implementations, at least one of the one or more protection devices further includes an integrated temperature sensor.

In some implementations, a first node connects a positive terminal of the first high voltage battery, an input of a first relay, one input of a first protection device, and one input of a third protection device, wherein outputs of the third protection device connect to first and second charging outputs, a second node connects a negative terminal of the first high voltage battery, another input of the first protection device, an input of a third relay, and an input of a fifth relay, a third node connects a positive terminal of the second high voltage battery, an output of the fifth relay, an input of a second relay, and one input of a second protection device, a fourth node connects a negative terminal of the second high voltage battery, another input of the second protection device, and an input of a fourth relay, a fifth node connects an output of the first relay, one output of the first protection device, another input of the third protection device, an output of the second protection device, the fourth node, and a first auxiliary output, and a sixth node connects another output of the first protection device, an output of the third relay, another output of the second protection device, an output of the fourth relay, and a second auxiliary output.

In some implementations, the controller is configured to control the switchable BDU to transition from standby to a drive mode by commanding the following sequence: close the fourth relay, close the second relay, close the contactor of the second protection device, open the second and fourth relays, and close the contactor of the first protection device, wherein both the first and second high voltage batteries are connected to the electrified powertrain via the first and second auxiliary outputs. In some implementations, the controller is configured to control the switchable BDU to transition from standby to a 400V charging mode by commanding the following sequence: close the fourth relay, close the second relay, close the contactor of the second protection device, open the second and fourth relays, close the contactor of the first protection device, and close the contactor of the third protection device, wherein both the first and second high voltage batteries are thereby connected, through the third protection device in parallel, to a DC fast charging station via the first and second charging outputs, and wherein both the first and second high voltage batteries are also connected to an auxiliary circuit via the first and second auxiliary outputs.

In some implementations, the controller is configured to control the switchable BDU to transition from standby to an 800V charging mode by commanding the following sequence: close the third relay, close the first relay, open the contactor of the first protection device, open the third and first relays, close the fifth relay, and close the contactor of the third protection device, wherein both the first and second high voltage batteries are connected, through the third protection device in series, to a DC fast charging station via the first and second charging outputs. In some implementations, the controller is further configured to control the switchable BDU to shift the auxiliary load from the first high voltage battery to the second high voltage battery by commanding the following sequence: open the contactor of the first protection device, close the fourth relay, close the second relay, close the contactor of the second protection device, and open the second and fourth relays.

According to another example aspect of the invention, a control method for a switchable BDU system for an electrified vehicle is presented. In one exemplary implementation, the control method comprises providing a switchable BDU for a high voltage battery system of the electrified vehicle, the switchable BDU including one or more protection devices that each include both a contactor and an integrated circuit breaker, controlling, by a controller, the switchable BDU to switch between 400V and 800V DC modes for powering an electrified powertrain of the electrified vehicle and for recharging the high voltage battery system, and monitoring and resetting, by the controller, the protection device in response to an actuation of the integrated circuit breaker, wherein the protection device does not include a replaceable thermal fuse.

In some implementations, the protection device is configured to actuate or open the integrated circuit breaker in response to a current spike. In some implementations, the actuation or opening of the integrated circuit breaker prevents the current spike from welding the contactor closed. In some implementations, the high voltage battery system is separable into first and second high voltage batteries, and wherein the switchable BDU includes three protection devices and five relays. In some implementations, at least one of the one or more protection devices further includes an integrated temperature sensor.

In some implementations, a first node connects a positive terminal of the first high voltage battery, an input of a first relay, one input of a first protection device, and one input of a third protection device, wherein outputs of the third protection device connect to first and second charging outputs, a second node connects a negative terminal of the first high voltage battery, another input of the first protection device, an input of a third relay, and an input of a fifth relay, a third node connects a positive terminal of the second high voltage battery, an output of the fifth relay, an input of a second relay, and one input of a second protection device, a fourth node connects a negative terminal of the second high voltage battery, another input of the second protection device, and an input of a fourth relay, a fifth node connects an output of the first relay, one output of the first protection device, another input of the third protection device, an output of the second protection device, the fourth node, and a first auxiliary output, and a sixth node connects another output of the first protection device, an output of the third relay, another output of the second protection device, an output of the fourth relay, and a second auxiliary output.

In some implementations, the control method further comprises controlling, by the controller, the switchable BDU to transition from standby to a drive mode by commanding the following sequence: close the fourth relay, close the second relay, close the contactor of the second protection device, open the second and fourth relays, and close the contactor of the first protection device, wherein both the first and second high voltage batteries are connected to the electrified powertrain via the first and second auxiliary outputs. In some implementations, the method further comprises controlling, by the controller, the switchable BDU to transition from standby to a 400V charging mode by commanding the following sequence: close the fourth relay, close the second relay, close the contactor of the second protection device, open the second and fourth relays, close the contactor of the first protection device, and close the contactor of the third protection device, wherein both the first and second high voltage batteries are thereby connected, through the third protection device in parallel, to a DC fast charging station via the first and second charging outputs, and wherein both the first and second high voltage batteries are also connected to an auxiliary circuit via the first and second auxiliary outputs.

In some implementations, the method further comprises controlling, by the controller, the switchable BDU to transition from standby to an 800V charging mode by commanding the following sequence: close the third relay, close the first relay, open the contactor of the first protection device, open the third and first relays, close the fifth relay, and close the contactor of the third protection device, wherein both the first and second high voltage batteries are connected, through the third protection device in series, to a DC fast charging station via the first and second charging outputs. In some implementations, the method further comprises controlling, by the controller, the switchable BDU to shift the auxiliary load from the first high voltage battery to the second high voltage battery by commanding the following sequence: open the contactor of the first protection device, close the fourth relay, close the second relay, close the contactor of the second protection device, and open the second and fourth relays.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example switchable battery disconnect unit (BDU) system according to the principles of the present application;

FIG. 2 is a circuit diagram for an example configuration of the switchable BDU system including a plurality of protection devices according to the principles of the present application;

FIG. 3 is a flow diagram of an example switchable BDU control method for an electrified vehicle according to the principles of the present application;

FIG. 4 is a functional block diagram of an example protection system for a switchable BDU for a multi-string battery pack or system of an electrified vehicle according to the principles of the present application;

FIGS. 5A-5C are circuit diagrams for the example configuration of the switchable BDU of FIG. 2 showing three potential short circuit malfunctions according to the principles of the present application; and

FIG. 6 is a flow diagram of an example protection method for a switchable BDU for a multi-string battery pack or system of an electrified vehicle according to the principles of the present application.

### DESCRIPTION

As previously discussed, conventional electrified vehicle high voltage architectures include separate contactors and thermal fuses. Replacing blown thermal fuses and/or welded contactors requires substantial service time/costs. Thus, there exists an opportunity for improvement in the relevant art. One particularly desirable high voltage architecture is a 400V/800V switchable battery disconnect unit (BDU) circuit that allows for both 400V boosted 800V fast charging, which includes multiple contactors and thermal fuses. Accordingly, improved switchable BDU systems and methods that utilize protection devices having contactors and integrated circuit breakers are presented herein. In some implementations, these protection devices could also integrate temperature sensors. Multiple protection devices could be implemented in an existing 400V/800V switchable BDU architecture in place of existing contactors and thermal fuses to achieve the same functionality without the drawbacks of time consuming and expensive service as described above. In addition to reduced service time/costs, the switchable BDU provides for more charging options and a faster/better customer experience.

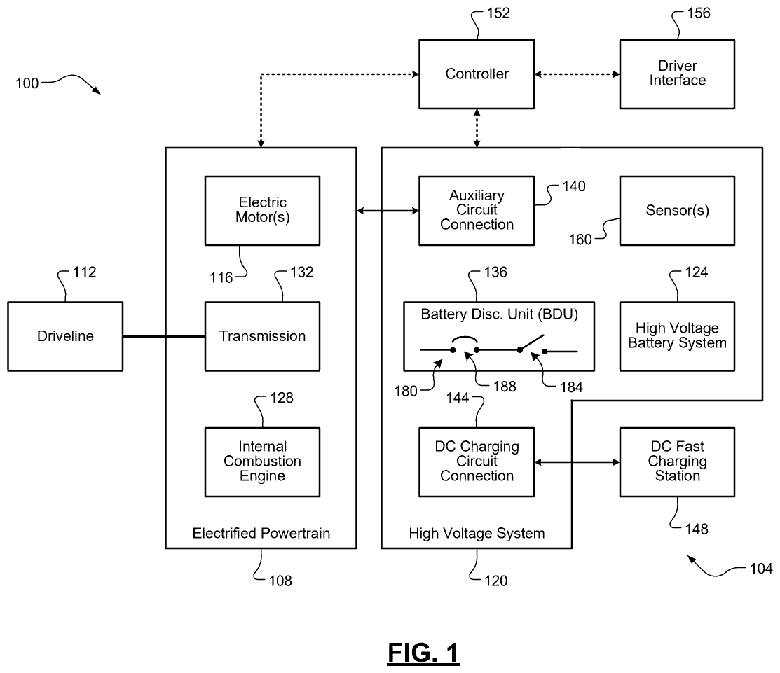

Referring now to FIG. 1, a functional block diagram of an electrified vehicle 100 having an example switchable BDU system 104 according to the principles of the present application is illustrated. The electrified vehicle 100 (also referred to as “vehicle 100”) generally comprises an electrified powertrain 108 configured to generate and transfer drive torque to a driveline 112 for vehicle propulsion. The electrified powertrain 108 includes one or more electric motors 116 that are powered by high voltage power provided by a high voltage system 120 that includes a high voltage battery system 124. In some implementations, the electrified powertrain 108 has a hybrid configuration and also includes an optional internal combustion engine 128 configured to combust a mixture of air and liquid fuel (gasoline, diesel, etc.) to generation mechanical energy (drive torque), which could be converted into electrical energy (e.g., for battery recharging and/or powering auxiliary loads). A transmission 132 (e.g., a multi-speed automatic transmission) transfers the drive torque to the driveline 112.

The high voltage system 120 further comprises a switchable BDU 136 that is configured to connect the high voltage battery system 124 to auxiliary loads (e.g., the electrified powertrain 108) via an auxiliary circuit connection 140 or to a charging system (e.g., a DC fast charging station 148) via a DC charging circuit connection 144. A controller 152 is configured to control operation of the electrified vehicle 100. This includes, for example, controlling the electrified powertrain 108 to generate and transfer an amount of drive torque to satisfy a torque request, which could be provided by a driver of the electrified vehicle 100 via a driver interface 156 (e.g., an accelerator pedal). The controller 152 could also control the switchable BDU 136 as part of the control techniques of the present application. This could include, for example, receiving measurements from one or more sensors 160 (current sensors, voltage sensors, temperature sensors, etc.) associated with the high voltage system 120. It will also be appreciated that the switchable BDU 136 could include its own controller, such as a battery management system (BMS).

The switchable BDU 136 is switchable in that it is configured to enable both 400V DC fast charging as well as boosted 800V DC fast charging. The switchable BDU 136 includes one or more protection devices 180 according to some implementations of the present application, which provide for both power connection/transfer (via a contactor 184 or switch/relay) and circuit protection (via an integrated circuit breaker 188, e.g., in series with the contactor). It will be appreciated that the illustrated example configuration 180 is merely one example configuration of the protection device(s) 180 and that they could have other suitable configurations include at least the contactor 184 and an integrated circuit breaker 188. It will also be appreciated, however, that at least some of the above- described sensor functionality (i.e., sensor(s) 160) could be integrated into these protection devices (e.g., current spike sensing to open the circuit breaker, as well as optional temperature sensing). Depending on the specific configuration of the electrified vehicle 100 and, more particularly, the high voltage system 120, the switchable BDU 136 according to the present application could include any suitable number of these protection devices (i.e., one or more protection devices). An example configuration of and a description of the operation of the switchable BDU 136 will now be described in greater detail.

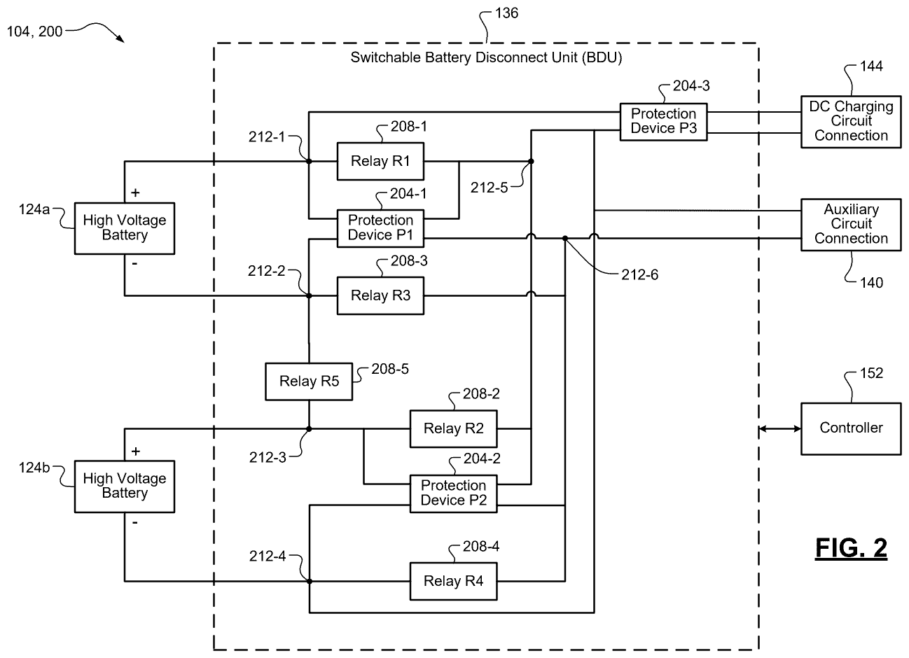

Referring now to FIG. 2, a circuit diagram for an example configuration 200 of the switchable BDU system 104 and the switchable BDU 136 including a plurality of protection devices 204 according to the principles of the present application is illustrated. As previously discussed, the switchable BDU system 104 includes the switchable BDU 136 and the controller 152 or another suitable control system, such as a BMS. As shown, the switchable BDU 136 includes three protection devices 204-1 . . . 204-3 (collectively, “protection devices 204”) that are also labeled P1 . . . P3, respectively. The switchable BDU 136 also includes five contactors, switches, or relays 208-1 . . . 208-5 (collectively, “relays 208”) that are also labeled R1 . . . R5, respectively. The high voltage battery system 124 is dividable into two high voltage batteries 124a, 124b as the high voltage battery system 124 is a combination of a plurality of smaller battery cells connected in series to collectively provide a much higher overall voltage (400V DC, 800V DC, etc.). The protection devices 204 and the relays 208 are controllable (e.g., by controller 152) to open/close in desired patterns in order to provide the desired functionality. Nodes 212-1 . . . 212-6 (collectively, “nodes 212”) are also labeled to define connections between the various components of the switchable BDU 136. It will be appreciated that these are the primary components of the switchable BDU 136 and that there could be other non-illustrated components, such as one or more fuses.

For example, in a first “standby to drive” mode transition, the following sequence is commanded: R4 closes, R2 closes, P2 closes, R2 and R4 open, and then P1 closes. In doing so, both high voltage batteries 124a and 124b are connected to the auxiliary circuit (e.g., the electrified powertrain 108) via the auxiliary circuit connection 140. Also for example, in a second “standby to 400V charge” mode transition, the following sequence is commanded: R4 closes, R2 closes, P2 closes, R2 and R4 open, P1 closes, and then P3 closes. In doing so, both of the high voltage batteries 124a and 124b are connected, through P3 in parallel, to a charging system (e.g., DC fast charging system 148) via the charging circuit connection 144, and both of the high voltage batteries 124a and 124b are also connected to the auxiliary circuit via the auxiliary circuit connection 140. Also for example, in a third “standby to 800V charge” mode transition, the following sequences are commanded. First: R3 closes, R1 closes, P1 closes, R3 and R1 open, R5 closes, and P3 closes. Next, to shift the auxiliary load from the first high voltage battery 124a to the second high voltage battery 124b: P1 opens, R4 closes, R2 closes, P2 closes, and then R2 and R4 open. Thus, both of the high voltage batteries 124a and 124b are connected, through P3 in series, to the charging circuit (e.g., the DC fast charging station 148) via the charging circuit connection 144.

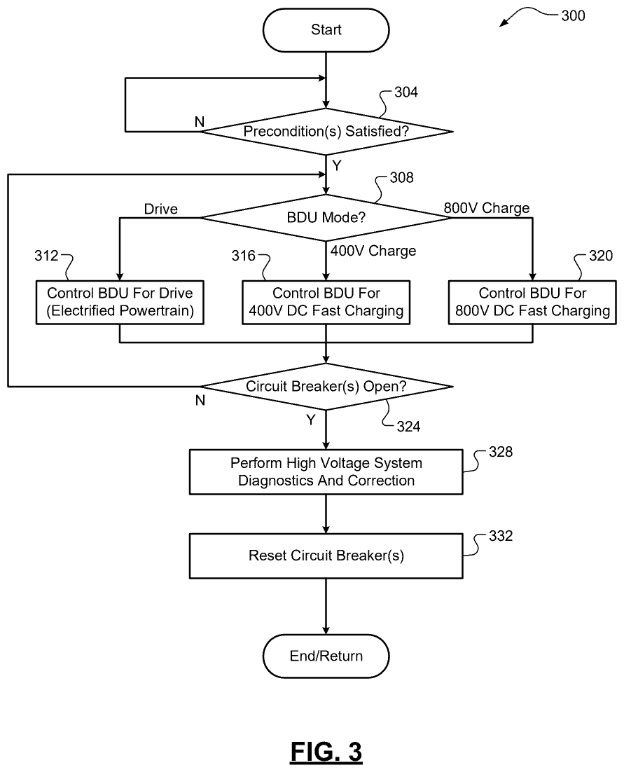

Referring now to FIG. 3, a flow diagram of an example switchable BDU control method 300 for an electrified vehicle according to the principles of the present application is illustrated. While the electrified vehicle 100 and its components (e.g., switchable BDU system 104) are specifically referenced for illustrative/descriptive purposes, it will be appreciated that the method 300 could be applicable to any suitable electrified vehicle high voltage architecture. At 304, the controller 152 optionally determines whether a set of one or more preconditions are satisfied. This could include, for example, the electrified vehicle 100 being powered up and the switchable BDU 136 being in a standby mode and, there being no malfunctions present that would otherwise inhibit the operation of the electrified vehicle 100 and, more particularly, the control of the switchable BDU 136 according to the techniques of the present application. When false, the method 300 ends or returns to 304. When true, the method 300 continues to 308. At 308, the controller 152 determines a desired mode for the switchable BDU 136. This desired mode could be, for example, a transition from the standby mode to one of a drive mode, a 400V charging mode, and an 800V charging mode.

When the desired mode is the drive mode, the method 300 proceeds to 312 where the controller 152 controls the switchable BDU 136 as previously described herein to connect the high voltage batteries 124a, 124b to the auxiliary output (e.g., the electrified powertrain 108) via the auxiliary circuit connection 140. The method 300 then continues to 324. When the desired mode is the 400V charging mode, the method 300 proceeds to 316 where the controller 152 controls the switchable BDU 136 as previously described herein to connect both the first and second high voltage batteries 124a, 124b, through the third protection device 204-3 (P3) in parallel, to a charging system (e.g., the DC fast charging station 148) via the charging circuit connection 144. In this mode, the first and second high voltage batteries 124a, 124b could also be connected to the auxiliary output via the auxiliary circuit connection 140. The method 300 then continues to 324. When the desired mode is the 800V charging mode, the method 300 proceeds to 320 where the controller 152 controls the switchable BDU 136 as previously described herein to connect both the first and second high voltage batteries 124a, 124b, through the third protection device 204-3 (P3) in series, to the charging system (e.g., the DC fast charging station 148) via the charging circuit connection 144.

In this mode, the controller 152 could also control the switchable BDU 136 as previously described herein to shift the auxiliary load from the first high voltage battery 124a to the second high voltage battery 124b. The method 300 then continues to 324. At 324, the controller 152 monitors the protection devices 204 to determine whether any of their integrated circuit breakers have been tripped/actuated or opened. When false, the method 300 ends or returns to 308 and continues operation (e.g., until a mode change for the switchable BDU 136). When true, the method 300 continues to 328. At 328, the controller 152 performs diagnostics and possible remedial action or correction of any malfunctions or faults at the high voltage system 120. This could also include setting one or more diagnostic flags, which could then require further diagnostics by a human service technician. Once the malfunctions/faults that caused the circuit breaker(s) to actuate/open are resolved, the method 300 proceeds to 332 where the controller 152 resets the circuit breaker(s) of the protection devices 204 to a closed position. The method 300 then ends.

In another aspect of the present application, short circuit protection techniques for electrified vehicle multi-string battery packs or systems connected via a switchable BDU are presented herein. While these protection techniques will be described with respect to the electrified vehicle 100, including high voltage battery system 124 including first and second high voltage batteries 124a and 124b, respectively, and switchable BDU 136, it will be appreciated that these protection techniques could be applicable to other electrified vehicle multi-string battery packs or systems having switchable BDUs. The term “battery string” as used herein refers to a battery (e.g., first battery 124a or second battery 124b) that is a subset of a larger battery system (e.g., high voltage battery system 124; also “battery system 124” herein). In certain operating scenarios (e.g., corner cases), the switchable BDU 136 could be configured (via the protection devices 204 and switches or relays 208) such that a short circuit malfunction is likely or will occur between the two battery strings 124a, 124b.

In addition to unforeseen corner cases, a controller (e.g., controller 152, such as a battery management system or BMS) may not intentionally command the switchable BDU 136 to a particular configuration that is likely to or will cause a short circuit malfunction. Various hardware or software malfunctions, for example, could cause the switchable BDU 136 to transition to an unintended or unforeseen state (i.e., different than what is commanded). Absent these protection systems and methods of the present application, both (i) human operators (e.g., calibration engineers) working with the switchable BDU 136 and the battery system 124 could be subject to potentially dangerous shock conditions and (ii) the switchable BDU 136 and, more particularly, the battery system 124 (including battery strings 124a and 124b) could be subject to potential damage or reduced life. Thus, these protection systems and methods utilize a specific final state mapping for the various states of the protection devices 204 and relays 208 of the switchable BDU 136. This final state mapping, compared to an initial state mapping for all of the possible combinations of states of the protection devices 204 and relays 208, does not include identified malfunction states that are likely to or will cause short circuit malfunctions of the battery system 124.

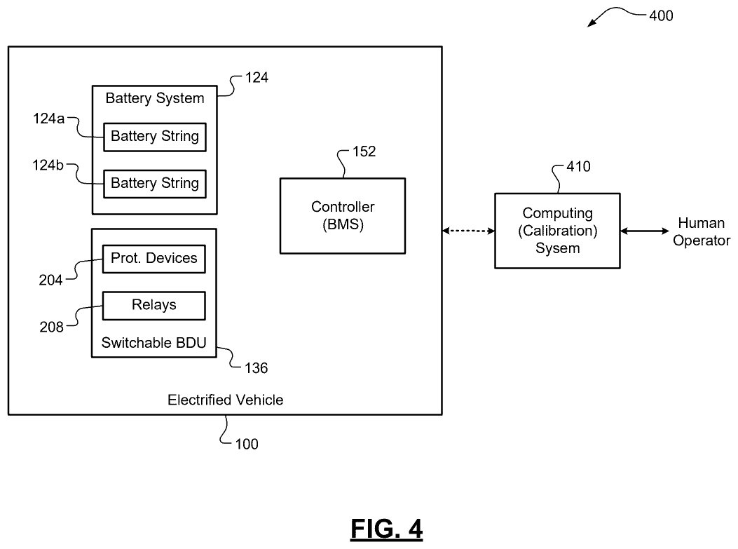

In the illustrated example of FIG. 2, there could be three different malfunction states that will be identified and removed from the initial state mapping to obtain the final state mapping for controlling the switchable BDU 136, such that the switchable BDU 136 cannot enter one of these malfunction states, thereby preventing potential harm to the operator or battery system. Referring now to FIG. 4 and with continued reference to the previous figures, a functional block diagram of an example protection system 400 for a switchable BDU for a multi-string battery pack or system of an electrified vehicle according to the principles of the present application. Again, while the switchable BDU 136 and the battery system 124 of electrified vehicle 100 are specifically referenced for descriptive/illustrative purposes, it will be appreciated that the example protection system 400 could be implemented with another electrified vehicle having a slightly different multi-string battery pack or system and a switchable BDU. As shown, a computing system 410 is external to the electrified vehicle 100 and is configured to perform calibration of the switchable BDU 136 to implement the protection techniques of the present application. The computing system 410 can be operated by a human user (e.g., a calibration engineer).

The process begins with an initial state mapping of all of the possible combinations of states (e.g., OPEN vs. CLOSED) of the protection devices 204 and relays 208 of the switchable BDU 136. After this final state mapping is obtained at the computing device 400, it can be uploaded (e.g., via any suitable wired or wireless communication link) to the controller 152 of the electrified vehicle 100, which can store it at a memory (not shown). The controller 152 can then utilize the final state mapping to control the switchable BDU 136 and thereby avoid commanding the switchable BDU 136 into any of the malfunction state(s) that is likely to or will cause a short circuit malfunction. The human user can identify (e.g., via modeling or other analysis) which states of the initial state mapping are likely to or will cause a short circuit malfunction of the battery system 124. These identified malfunction state(s) are then removed from the initial state mapping to obtain a modified (final) mapping that has the malfunction states removed therefrom.

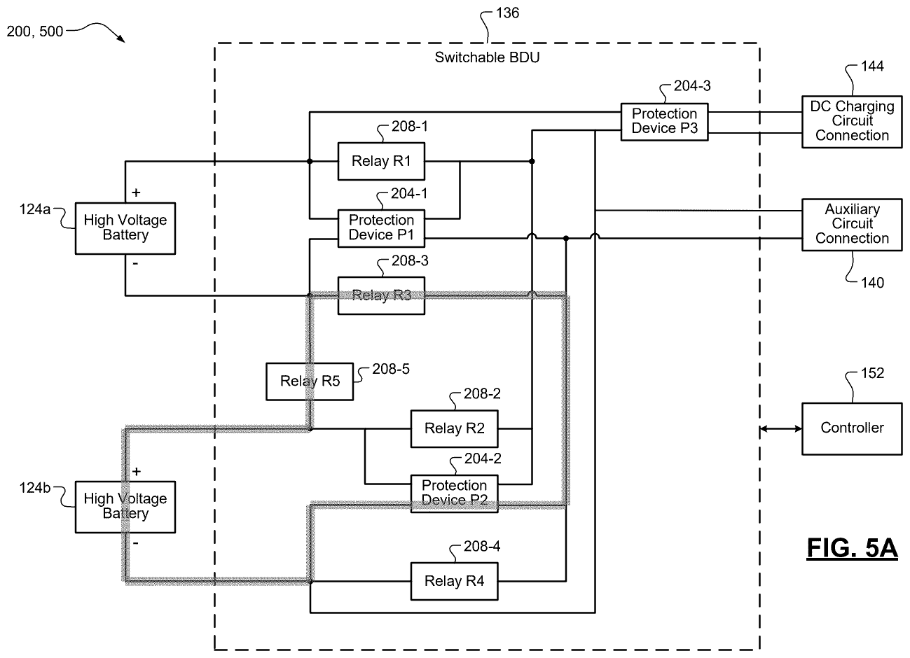

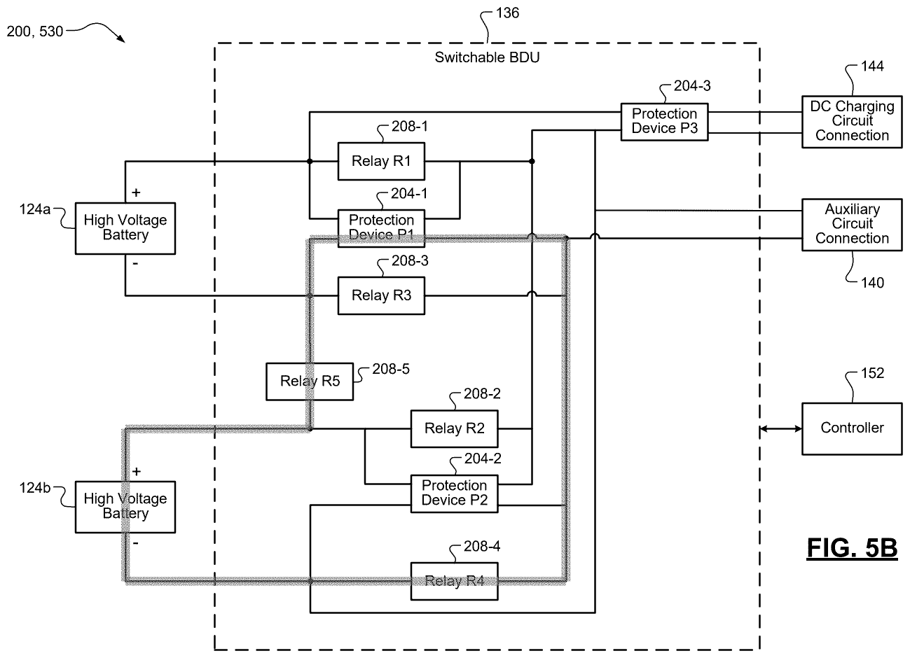

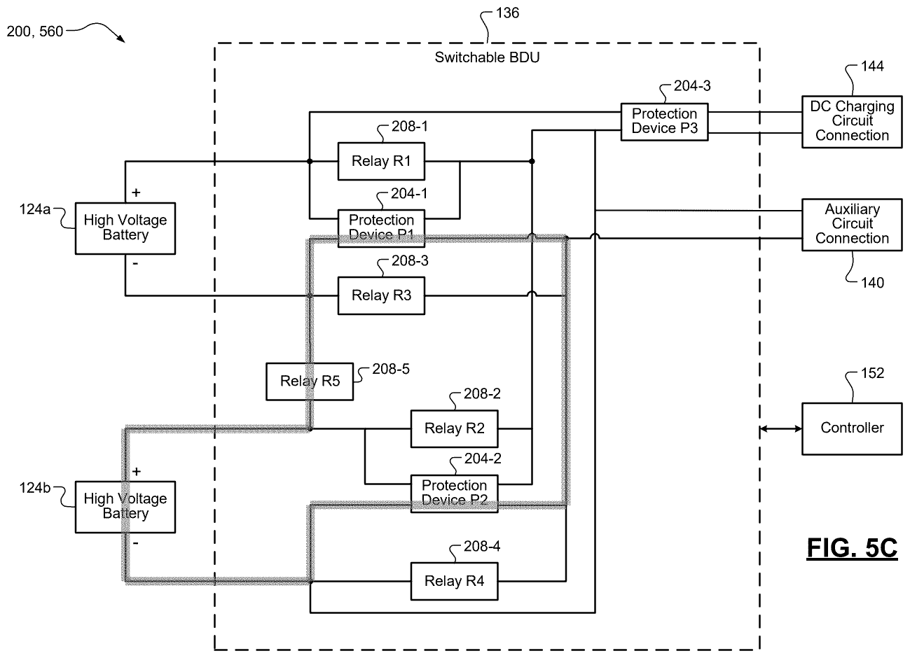

Referring now to FIGS. 5A-5C and with continued reference to the previous figures, circuit diagrams 500, 530, and 560 for the example configuration of the switchable BDU 136 (from FIG. 2) illustrate three potential short circuit malfunctions according to the principles of the present application. It will be appreciated that these are merely example short circuit malfunctions for this particular configuration 200 of the switchable BDU 136 and that there could potentially be other unknown or unforeseen corner cases for this configuration 200 and that the specific short circuit malfunctions could vary depending on the specific configuration of the switchable BDU 136 (i.e., different short circuit malfunctions for different configurations of the switchable BDU 136). In each of these example short circuit malfunctions, the protection devices 204 and the relays 208 are configured according to a state mapping, which specifies a state (e.g., ON or OFF, CLOSED or OPEN) of each of the protection devices 204 and the relays 208. As shown, the two battery strings 124a and 124b are generally separated by a relay R5 208-5 that, when CLOSED or ON, connects the battery strings 124a and 124b in series (also known as a “series relay”).

In FIG. 5A, a first example short circuit malfunction 500 involves relay R5 208-5, relay R3 208-3, and protection device P2 204-2 are all switched ON or CLOSED simultaneously. This results in the highlighted connective path, which causes a short circuit across battery string 124b. In FIG. 5B, a second example short circuit malfunction 530 involves relay R5 208-5, protection device P1 204-1, and relay R4 208-4 are all switched ON or CLOSED simultaneously. This results in the highlighted connective path, which causes a short circuit across battery string 124b. In FIG. 5C, a third example short circuit malfunction 560 involves relay R5 208-5, protection device P1 204-1, and protection device P2 204-2 are all switched ON or CLOSED simultaneously. This results in the highlighted connective path, which causes a short circuit across battery string 124b. In conventional systems, calibration overrides (e.g., by calibration engineers) can override normal operation of the switchable BDU 136 to command the switchable BDU 136 to one of these malfunction states 500, 530, or 560. These calibration overrides can be additional signals that are gated for allowing the specific protection devices 204 and relays 208 to be switched ON or CLOSED in specific combinations. In contrast, during normal operation, a special weld check could be performed during the closing of relay R5 208-5 to prevent these malfunction states 500, 530, and 560 from occurring.

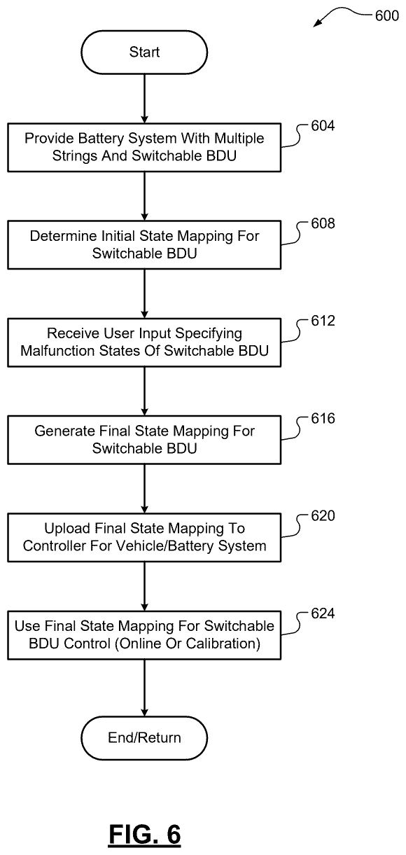

Referring now to FIG. 6 and with continued reference to the previous figures, a flow diagram of an example protection method 600 for a switchable BDU for a multi-string battery pack or system of an electrified vehicle according to the principles of the present application is illustrated. Again, while the method 600 specifically references, for descriptive and illustrative purposes, protection system 400 and electrified vehicle 100, including the switchable BDU 136 and the high voltage battery system 124, it will be appreciated that the method 600 could be applicable to any suitably configured protection system and electrified vehicle multi-string battery pack or system having a switchable BDU. The method 600 begins at 604 where the battery system 124 having multiple battery strings 124a and 124b connectable via the switchable BDU 136 is provided. In one example embodiment, the switchable BDU 136 has the configuration 200 illustrated in FIG. 2. At 608, the computing system 400 determines an initial state mapping for all potential combinations of states of the set of protection devices 204 and the set of relays 208 of the switchable BDU 136. At 612, the computing system 400 determines one or more malfunction states of the initial state mapping, each malfunction state being a particular combinations of states of the set of protection devices 204 and the set of relays 208 that will cause a short circuit malfunction of the battery system 124.

In both 608 and 612, the computing system 400 can receive input (e.g., via a user interface of the computing system 400) from a human operator, such as a calibration engineer. For example, this input could be a two-dimensional (2D) look-up table or similar data structure specifying all of the various combinations of states of protection devices 204 and relays 208 and, for each of the various state combinations, an ALLOW or DISALLOW state. For the initial state mapping, all of the various state combinations could be set to ALLOW. At 608, the input to the computing system 400 identifies the malfunction states of the various combinations of states. At 616, the computing system 400 generates a final state mapping for the combinations of states of protection devices 204 and relays 208 based on the initial state mapping and the identified malfunction states. For example, the computing system 400 could change any identified malfunction states from ALLOW to DISALLOW in the final state mapping. It will be appreciated that other user/computing system interactions could utilized to obtain the final state mapping, such as the human user (e.g., a calibration engineer) unchecking or unselecting specific state combinations from the initial state mapping (i.e., changing from ALLOW to DISALLOW) according to information that he/she has predetermined (e.g., previously identified malfunction states).

At 620, the computing system 400 can upload the final state mapping for the switchable BDU 136 to the controller 152 (e.g., a BMS) for subsequent use in controlling the switchable BDU 136. At 624, the controller 152 receives the final state mapping, stores it in a memory (not shown), and subsequently uses the final state mapping to control the states of protection devices 204 and relays 208 of the switchable BDU 136. This usage could be both during development/testing, where calibration engineers test software for controlling the switchable BDU 136, or online (real-time) usage by the electrified vehicle 100 after it has been deployed to a customer. In both uses, the final state mapping is used to prevent short circuit malfunctions switchable BDU 136 to switch between the two DC modes (e.g., 400V or 800V) for both powering the electrified powertrain 108 of the electrified vehicle 100 (i.e., discharging the battery system 124) and for recharging the battery system 124. In the calibration usage, the final state mapping also protects the calibration engineer(s) from potential harm (e.g., electrical shock) due to a short circuit malfunction. The method 600 then ends or returns to 604 for another calibration procedure.

According to another aspect of the invention, a short circuit protection system for a battery system of an electrified vehicle is presented. In one exemplary implementation, the short circuit protection system comprises a switchable BDU including (i) a set of protection devices each including both a contactor and an integrated circuit breaker and (ii) a set of relays and being configured to selectively connect and disconnect first and second battery strings of the battery system to switch the battery system between first and second DC modes, respectively, and a computing system configured to determine an initial state mapping for all potential combinations of states of the set of protection devices and the set of relays, determine one or more malfunction states of the initial state mapping, each malfunction state being a particular combinations of states of the set of protection devices and the set of relays that will cause a short circuit malfunction of the battery system, and generate a final state mapping based on the initial state mapping and the one or more malfunction states such that the final state mapping does not allow the switchable BDU to be configured in any of the one or more malfunction states, wherein the final state mapping is thereafter used to control the switchable BDU while also protecting the battery system and nearby calibration engineers from any short circuit malfunctions of the battery system.

In some implementations, the computing system is separate and external to the electrified vehicle, and wherein the computing system is configured to upload the final state mapping to a controller of the electrified vehicle for storage and usage in controlling the switchable BDU. In some implementations, the computing system is configured to determine the one or more malfunction states based on input received from one of the calibration engineers. In some implementations, the switchable BDU includes three protection devices and five relays. In some implementations, a first node connects a positive terminal of the first battery string, an input of a first relay, one input of a first protection device, and one input of a third protection device, wherein outputs of the third protection device connect to first and second charging outputs, a second node connects a negative terminal of the first battery string, another input of the first protection device, an input of a third relay, and an input of a fifth relay, a third node connects a positive terminal of the second battery string, an output of the fifth relay, an input of a second relay, and one input of a second protection device, a fourth node connects a negative terminal of the second battery string, another input of the second protection device, and an input of a fourth relay, a fifth node connects an output of the first relay, one output of the first protection device, another input of the third protection device, an output of the second protection device, the fourth node, and a first auxiliary output, and a sixth node connects another output of the first protection device, an output of the third relay, another output of the second protection device, an output of the fourth relay, and a second auxiliary output.

In some implementations, a first malfunction state of the switchable BDU that is not included in the final state mapping corresponds to a substantially simultaneous enablement or closure of (i) the fifth relay, (ii) the third relay, and (iii) the second protection device. In some implementations, a second malfunction state of the switchable BDU that is not included in the final state mapping corresponds to a substantially simultaneous enablement or closure of (i) the fifth relay, (ii) the first protection device, and (iii) the fourth relay. In some implementations, a third malfunction state of the switchable BDU that is not included in the final state mapping corresponds to a substantially simultaneous enablement or closure of (i) the fifth relay, (ii) the first protection device, and (iii) the second protection device. In some implementations, the control of the switchable BDU by the controller of the electrified vehicle includes monitoring and resetting a particular protection device in response to an actuation of its respective integrated circuit breaker, wherein each protection device does not include a replaceable thermal fuse. In some implementations, each protection device is configured to actuate or open its respective integrated circuit breaker in response to a current spike to prevent the current spike from welding its respective contactor closed.

According to another aspect of the invention, a short circuit protection method for a battery system of an electrified vehicle is presented. In one exemplary implementation, the short circuit protection method comprises providing a switchable BDU including (i) a set of protection devices each including both a contactor and an integrated circuit breaker and (ii) a set of relays and being configured to selectively connect and disconnect first and second battery strings of the battery system to switch the battery system between first and second direct current (DC) modes, respectively, determining, by a computing system, an initial state mapping for all potential combinations of states of the set of protection devices and the set of relays, determining, by the computing system, one or more malfunction states of the initial state mapping, each malfunction state being a particular combinations of states of the set of protection devices and the set of relays that will cause a short circuit malfunction of the battery system, and generating, by the computing system, a final state mapping based on the initial state mapping and the one or more malfunction states such that the final state mapping does not allow the switchable BDU to be configured in any of the one or more malfunction states, wherein the final state mapping is thereafter used to control the switchable BDU while also protecting the battery system and nearby calibration engineers from any short circuit malfunctions of the battery system.

In some implementations, the computing system is separate and external to the electrified vehicle, and wherein the computing system is configured to upload the final state mapping to a controller of the electrified vehicle for storage and usage in controlling the switchable BDU. In some implementations, the determining, by the computing system, of the one or more malfunction states is based on input received from one of the calibration engineers. In some implementations, the switchable BDU includes three protection devices and five relays. In some implementations, a first node connects a positive terminal of the first battery string, an input of a first relay, one input of a first protection device, and one input of a third protection device, wherein outputs of the third protection device connect to first and second charging outputs, a second node connects a negative terminal of the first battery string, another input of the first protection device, an input of a third relay, and an input of a fifth relay, a third node connects a positive terminal of the second battery string, an output of the fifth relay, an input of a second relay, and one input of a second protection device, a fourth node connects a negative terminal of the second battery string, another input of the second protection device, and an input of a fourth relay, a fifth node connects an output of the first relay, one output of the first protection device, another input of the third protection device, an output of the second protection device, the fourth node, and a first auxiliary output, and a sixth node connects another output of the first protection device, an output of the third relay, another output of the second protection device, an output of the fourth relay, and a second auxiliary output.

In some implementations, a first malfunction state of the switchable BDU that is not included in the final state mapping corresponds to a substantially simultaneous enablement or closure of (i) the fifth relay, (ii) the third relay, and (iii) the second protection device. In some implementations, a second malfunction state of the switchable BDU that is not included in the final state mapping corresponds to a substantially simultaneous enablement or closure of (i) the fifth relay, (ii) the first protection device, and (iii) the fourth relay. In some implementations, a third malfunction state of the switchable BDU that is not included in the final state mapping corresponds to a substantially simultaneous enablement or closure of (i) the fifth relay, (ii) the first protection device, and (iii) the second protection device. In some implementations, the control of the switchable BDU by the controller of the electrified vehicle includes monitoring and resetting a particular protection device in response to an actuation of its respective integrated circuit breaker, wherein each protection device does not include a replaceable thermal fuse. In some implementations, each protection device is configured to actuate or open its respective integrated circuit breaker in response to a current spike to prevent the current spike from welding its respective contactor closed.

It will be appreciated that the terms “controller” and “control system” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A short circuit protection system for a battery system of an electrified vehicle, the short circuit protection system comprising:
a switchable battery disconnect unit (BDU) including (i) a set of protection devices each including both a contactor and an integrated circuit breaker and (ii) a set of relays and being configured to selectively connect and disconnect first and second battery strings of the battery system to switch the battery system between first and second direct current (DC) modes, respectively; and
a computing system configured to:
determine an initial state mapping for all potential combinations of states of the set of protection devices and the set of relays;
determine one or more malfunction states of the initial state mapping, each malfunction state being a particular combinations of states of the set of protection devices and the set of relays that will cause a short circuit malfunction of the battery system; and
generate a final state mapping based on the initial state mapping and the one or more malfunction states such that the final state mapping does not allow the switchable BDU to be configured in any of the one or more malfunction states,
wherein the final state mapping is thereafter used to control the switchable BDU while also protecting the battery system and nearby calibration engineers from any short circuit malfunctions of the battery system.

2. The short circuit protection system of claim 1, wherein the computing system is separate and external to the electrified vehicle, and wherein the computing system is configured to upload the final state mapping to a controller of the electrified vehicle for storage and usage in controlling the switchable BDU.

3. The short circuit protection system of claim 1, wherein the computing system is configured to determine the one or more malfunction states based on input received from one of the calibration engineers.

4. The short circuit protection system of claim 1, wherein the switchable BDU includes three protection devices and five relays.

5. The short circuit protection system of claim 4, wherein:
a first node connects a positive terminal of the first battery string, an input of a first relay, one input of a first protection device, and one input of a third protection device, wherein outputs of the third protection device connect to first and second charging outputs;
a second node connects a negative terminal of the first battery string, another input of the first protection device, an input of a third relay, and an input of a fifth relay;
a third node connects a positive terminal of the second battery string, an output of the fifth relay, an input of a second relay, and one input of a second protection device;
a fourth node connects a negative terminal of the second battery string, another input of the second protection device, and an input of a fourth relay;
a fifth node connects an output of the first relay, one output of the first protection device, another input of the third protection device, an output of the second protection device, the fourth node, and a first auxiliary output; and
a sixth node connects another output of the first protection device, an output of the third relay, another output of the second protection device, an output of the fourth relay, and a second auxiliary output.

6. The short circuit protection system of claim 5, wherein a first malfunction state of the switchable BDU that is not included in the final state mapping corresponds to a substantially simultaneous enablement or closure of (i) the fifth relay, (ii) the third relay, and (iii) the second protection device.

7. The short circuit protection system of claim 6, wherein a second malfunction state of the switchable BDU that is not included in the final state mapping corresponds to a substantially simultaneous enablement or closure of (i) the fifth relay, (ii) the first protection device, and (iii) the fourth relay.

8. The short circuit protection system of claim 7, wherein a third malfunction state of the switchable BDU that is not included in the final state mapping corresponds to a substantially simultaneous enablement or closure of (i) the fifth relay, (ii) the first protection device, and (iii) the second protection device.

9. The short circuit protection system of claim 1, wherein the control of the switchable BDU by the controller of the electrified vehicle includes monitoring and resetting a particular protection device in response to an actuation of its respective integrated circuit breaker, wherein each protection device does not include a replaceable thermal fuse.

10. The short circuit protection system of claim 9, wherein each protection device is configured to actuate or open its respective integrated circuit breaker in response to a current spike to prevent the current spike from welding its respective contactor closed.

11. A short circuit protection method for a battery system of an electrified vehicle, the short circuit protection method comprising:
providing a switchable battery disconnect unit (BDU) including (i) a set of protection devices each including both a contactor and an integrated circuit breaker and (ii) a set of relays and being configured to selectively connect and disconnect first and second battery strings of the battery system to switch the battery system between first and second direct current (DC) modes, respectively;
determining, by a computing system, an initial state mapping for all potential combinations of states of the set of protection devices and the set of relays;
determining, by the computing system, one or more malfunction states of the initial state mapping, each malfunction state being a particular combinations of states of the set of protection devices and the set of relays that will cause a short circuit malfunction of the battery system; and
generating, by the computing system, a final state mapping based on the initial state mapping and the one or more malfunction states such that the final state mapping does not allow the switchable BDU to be configured in any of the one or more malfunction states,
wherein the final state mapping is thereafter used to control the switchable BDU while also protecting the battery system and nearby calibration engineers from any short circuit malfunctions of the battery system.

12. The short circuit protection method of claim 11, wherein the computing system is separate and external to the electrified vehicle, and wherein the computing system is configured to upload the final state mapping to a controller of the electrified vehicle for storage and usage in controlling the switchable BDU.

13. The short circuit protection method of claim 11, wherein the determining, by the computing system, of the one or more malfunction states is based on input received from one of the calibration engineers.

14. The short circuit protection method of claim 11, wherein the switchable BDU includes three protection devices and five relays.

15. The short circuit protection method of claim 14, wherein:
a first node connects a positive terminal of the first battery string, an input of a first relay, one input of a first protection device, and one input of a third protection device, wherein outputs of the third protection device connect to first and second charging outputs;
a second node connects a negative terminal of the first battery string, another input of the first protection device, an input of a third relay, and an input of a fifth relay;
a third node connects a positive terminal of the second battery string, an output of the fifth relay, an input of a second relay, and one input of a second protection device;
a fourth node connects a negative terminal of the second battery string, another input of the second protection device, and an input of a fourth relay;
a fifth node connects an output of the first relay, one output of the first protection device, another input of the third protection device, an output of the second protection device, the fourth node, and a first auxiliary output; and
a sixth node connects another output of the first protection device, an output of the third relay, another output of the second protection device, an output of the fourth relay, and a second auxiliary output.

16. The short circuit protection method of claim 15, wherein a first malfunction state of the switchable BDU that is not included in the final state mapping corresponds to a substantially simultaneous enablement or closure of (i) the fifth relay, (ii) the third relay, and (iii) the second protection device.

17. The short circuit protection method of claim 16, wherein a second malfunction state of the switchable BDU that is not included in the final state mapping corresponds to a substantially simultaneous enablement or closure of (i) the fifth relay, (ii) the first protection device, and (iii) the fourth relay.

18. The short circuit protection method of claim 17, wherein a third malfunction state of the switchable BDU that is not included in the final state mapping corresponds to a substantially simultaneous enablement or closure of (i) the fifth relay, (ii) the first protection device, and (iii) the second protection device.

19. The short circuit protection method of claim 11, wherein the control of the switchable BDU by the controller of the electrified vehicle includes monitoring and resetting a particular protection device in response to an actuation of its respective integrated circuit breaker, wherein each protection device does not include a replaceable thermal fuse.

20. The short circuit protection method of claim 19, wherein each protection device is configured to actuate or open its respective integrated circuit breaker in response to a current spike to prevent the current spike from welding its respective contactor closed.
